(19) United States
(12) Patent Application Publication
(10) Pub. No.: US 2009/0180531 A1
(43) Pub. Date: Jul. 16, 2009

(54) CODEC WITH PLC CAPABILITIES

(75) Inventors: Ron WEIN, Herzlia (IL); Eli Tzirkel, RaAnana (IL); Ran Mendelson, Rishon-LeZion (IL); Yaakov Stein, Jerusalem (IL)

Correspondence Address: MARTIN D. MOYNIHAN d/b/a PRTSI, INC., P.O. BOX 16446, ARLINGTON, VA, 22215, US

(73) Assignee: Radlive Ltd., Tel-Aviv (IL)

(21) Appl. No.: 12/349,576

(22) Filed: Jan. 7, 2009

Related U.S. Application Data
(60) Provisional application No. 61/006,318, filed on Jan. 7, 2008.

(51) Int. Cl. H04B 1/66; G10L 21/00

(52) U.S. Cl. 375/240; 704/500

(57) ABSTRACT

A method for encoding data, including processing the data one data window at a time, as follows: computing spectral components of data of a first frame of data using data from the one data window, selecting prominent spectral components of the data using a selection method appropriate for the data, and quantizing the prominent spectral components, thereby producing a frame of encoded data. A method for decoding data including frames of encoded data, by performing, for each frame, de-quantizing the frame of encoded data, thereby producing a frame of de-quantized encoded data, smoothing continuity of the de-quantized encoded data based, at least in part, on comparing values of the de-quantized encoded data with values of de-quantized encoded data of a prior frame, thereby producing a frame of smoothed data, and transforming the frame of smoothed data to a frame of time domain data. Related apparatus and methods are also described.

### RELATED APPLICATION/S

This application claims the benefit of U.S. Provisional Application No. 61/006,318 filed on Jan. 7, 2008. The contents of the above document are incorporated by reference as if fully set forth herein.

### FIELD AND BACKGROUND OF THE INVENTION

The present invention, in some embodiments thereof, relates to a method and system for encoding and/or decoding data for transmission, and more particularly, but not exclusively, to an audio codec.

The term codec is sometimes used in reference to integrated circuits, or chips which perform data conversion. In this context, the term is an acronym for “coder/decoder.”

The term codec is also an acronym that stands for “compression/decompression.” In this context, a codes is a method, or a computer program, that reduces the number of bytes taken up by large files and programs.

Background art references include:

Introduction to Digital Audio Coding and Standards, by M. Bosi, and R. E. Goldberg, Springer, 2002;

College Admissions and the Stability of Marriage, by D. Gale, and L. S. Shapley, published in American Mathematical Monthly 69, 1962;

Speech Analysis/Synthesis Based on a Sinusoidal Representation, by R. J. McAuley, and T. F. Quatieri, published in IEEE Trans. Acoustics, Speech, and Signal Processing ASSP-34(4), August 1986;

Sinusoidal Coding, by R. J. McAuley, and T. F. Quatieri, which is chapter 4 in W. B. Kleijn and K. K. Paliwal, editors, Speech Coding and Synthesis (pages 121-173). Elsevier Science B. V., 1995;

Psychoacoustics: Facts and Models, by E. Zwicker and H. Fastl, Springer-Verlag, 1990;

U.S. Pat. No. 6,430,529;

U.S. Pat. No. 6,968,309;

PCT Published Patent Application 2004/097797;

US Published Patent Application 2005/0166124A1;

US Patent Application Publication 2007/0094015A1; and

US Published Patent Application 2008/0046235A1.

The contents of the above-mentioned references are incorporated by reference as if fully set forth herein.

### SUMMARY OF THE INVENTION

The present invention, in some embodiments thereof, relates to a method and system for encoding and decoding data for transmission, and more particularly, but not exclusively, to an audio codec.

Some embodiments of the invention include a method for encoding a digital data stream, by splitting the stream into data windows, selecting prominent spectral components of each data window, and quantizing the selected spectral components of each data window into encoded data frames, thus producing a stream of encoded data frames. The encoding is optionally on a window-by-window basis. In an exemplary embodiment of the invention, data frames may be lost without unduly affecting reconstruction of the original data stream.

Some embodiments of the invention optionally include using small data windows, which correspond to short periods of time. A typical loss of a data frame corresponds to a loss of a small amount of data. Reasons for loss of a portion of the encoded stream may be actual loss, or jitter. Jitter results in late arrival of packets, which can be unacceptable in case of an audio application, since the late packets must often be discarded to avoid large latency in the conversation. A PLC (Packet Loss Concealment) scheme optionally produces replacement data in place of lost data packets. Each small data window includes prominent spectral component coding, and the coding is relatively exact.

Coding and decoding may produce artifacts, and the artifacts may be audible. By way of a non-limiting example, some artifacts caused by abrupt transitions which are not present in the original signal, may be heard as clicks or as ‘musical’ noise. As will be described below with reference to decoding, some embodiments of the invention smooth an output decoded stream so that the artifacts do not substantially affect quality of the output decoded stream.

Some embodiments of the invention optionally include packaging each encoded data frame in a transmission data packet. By way of a non-limiting example, each code frame is packaged in a TCP/IP packet, optionally for transmission over a TCP/IP network. Loss of a TCP/IP packet then corresponds to loss of an encoded frame, which optionally corresponds to loss of a data window. It is noted that loss may be caused by late arrival of a packet. In an audio codec, if a packet arrives later than a reasonable latency, the packet cannot be used, as the audio may have been played back, that is sounded, and there may be no further use for the late packet.

Some embodiments of the invention optionally include transmitting the encoded data frames using the User Datagram Protocol (UDP).

Other embodiments of the invention include a method for decoding a stream of encoded data frames, by de-quantizing each frame, producing frames of spectral components, smoothing frame-to-frame continuity of the spectral components in each frame by track matching, using a method such as a McAuley-Quatieri method, and transforming the smoothed spectral components to frames of time domain data, thereby producing a decoded digital data stream. Track matching is described in more detail below, with reference to FIG. 6 The track matching optionally uses a method such as the McAuley-Quatieri method, described in the above-mentioned Speech Analysis/Synthesis Based on a Sinusoidal Representation by R. J. McAuley and T. F. Quatieri.

In an exemplary embodiment of the invention, the window-by-window encoding supports a Packet Loss Concealment (PLC) scheme, in which missing frames are compensated for, and do not unduly affect reconstruction of the original data stream. The PLC scheme compensates for jitter, yet a jitter buffer is also optionally used, in some exemplary embodiments of the present invention.

The codec is optionally used as an audio codec and/or as a wideband audio codec. Optionally, the smoothing supports compensating for and hiding of audio artifacts caused by the encoding and by potential missing encoded frames, and/or late arriving frames, and/or data errors in encoded frame transmission.

Additional embodiments of the invention include apparatus for encoding, apparatus for decoding, circuitry for encoding, circuitry for decoding, and systems for transmission using the encoding and decoding methods.

According to an aspect of some embodiments of the present invention there is provided a method for encoding data, including processing the data one data window at a time, as follows, computing spectral components of data of a first frame of data using data from the one data window, selecting prominent spectral components of the data using a selection method appropriate for the data, and quantizing the prominent spectral components, thereby producing a frame of encoded data.

According to some embodiments of the invention, the frame of encoded data is smaller than the first frame of data, thereby achieving data compression. According to some embodiments of the invention, the frame of encoded data is packaged into one transmission packet.

According to some embodiments of the invention, the computing spectral components is performed separately for spectral components of a frequency above a specific frequency and separately for spectral components of a frequency below the specific frequency.

According to some embodiments of the invention, the computing the spectral components of the data is performed independently of data external to the first data frame.

According to some embodiments of the invention, the one data window is larger than the first data frame and computing the spectral components of data of a first frame of data includes using data from the one data window.

According to some embodiments of the invention, the encoding is performed with zero algorithmic latency.

According to some embodiments of the invention, the selection method is based, at least partly, on a model of spectral distribution of the data. According to some embodiments of the invention, the data includes audio data. According to some embodiments of the invention, the selection method is based, at least partly, on a psychoacoustic model.

According to some embodiments of the invention, the quantizing the prominent spectral components is performed independently for amplitude and phase of each frequency of the prominent spectral components.

According to some embodiments of the invention, the quantizing of the phase of a specific prominent spectral component is performed with a number of quantizing bits based, at least partly, on the frequency of the specific prominent spectral component and on at least one psychoacoustic criterion.

According to an aspect of some embodiments of the present invention there is provided a method for decoding data including frames of encoded data, by performing, for each frame, de-quantizing the frame of encoded data, thereby producing a frame of de-quantized encoded data, smoothing continuity of the de-quantized encoded data based, at least in part, on comparing values of the de-quantized encoded data with values of de-quantized encoded data of a prior frame, thereby producing a frame of smoothed data, and transforming the frame of smoothed data to a frame of time domain data.

According to some embodiments of the invention, the smoothing continuity of the de-quantized encoded data is performed by using a Gale-Shapley pairing method, and interpolating between each pair of values.

According to some embodiments of the invention, the decoding is performed with a latency of one frame.

According to some embodiments of the invention, the method is used to implement a dynamic jitter buffer.

According to some embodiments of the invention, the frame of time domain data is of a different duration from a duration of a data window used to produce the frame of encoded data.

According to an aspect of some embodiments of the present invention there is provided a method for decoding a data stream including frames of encoded data, by performing, for each frame, de-quantizing a first frame of encoded data, thereby producing a first frame of de-quantized encoded data, transforming the frame of de-quantized encoded data to a frame of time domain data, producing a second frame of approximate encoded data based, at least in part, on the first frame of encoded data, and transforming the second frame of approximate encoded data to a second frame of time domain data.

According to some embodiments of the invention, further including de-quantizing a second frame of encoded data, thereby producing a third frame of de-quantized encoded data, transforming the third frame of de-quantized encoded data to a third frame of time domain data, and replacing the second frame of time domain data with the third frame of time domain data.

According to some embodiments of the invention, further including playing back the second frame of time domain data, and while playing back the second frame of time domain data switching to playing back the third frame of time domain data.

According to some embodiments of the invention, if a frame of encoded data is late arriving from the data stream, a replacement frame of encoded data is produced. According to some embodiments of the invention, if more than one frame of encoded data are missing from the data stream, more than one replacement frame of encoded data are produced.

According to some embodiments of the invention, the replacement frame of encoded data is produced based, at least in part, on extrapolating from a prior frame of encoded data.

According to some embodiments of the invention, the replacement frame of encoded data is produced based, at least in part, on interpolating between a prior frame of encoded data and a subsequent frame of encoded data.

According to an aspect of some embodiments of the present invention there is provided apparatus for encoding a stream of data including a spectral analysis unit configured for computing spectral components of the data, a selection unit configured for selecting prominent spectral components of the data, and a quantizing unit configured for quantizing the prominent spectral components thereby producing a frame of encoded data.

According to an aspect of some embodiments of the present invention there is provided apparatus for decoding a data stream including frames of encoded data including a de-quantizing unit configured for de-quantizing each frame of encoded data, thereby producing a frame of de-quantized encoded data, a track matching unit configured for smoothing continuity of the de-quantized encoded data, based at least in part on pairing values of the de-quantized encoded data with values of de-quantized encoded data of a prior frame, thereby producing a frame of smoothed data, and transforming the frame of smoothed data to a frame of time domain data.

According to an aspect of some embodiments of the present invention there is provided a codec scheme including encoding data, by processing the data one data frame at a time, as follows computing spectral components of the data, selecting prominent spectral components of the data using a selection method appropriate for the data, quantizing the prominent spectral components thereby producing a frame of encoded data, and appending each frame of encoded data to a prior frame of encoded data, thereby producing encoded data frames, and decoding the encoded data frames by processing the encoded data frames one frame at a time, as follows de-quantizing the encoded data frame, thereby producing a frame of de-quantized encoded data, smoothing continuity of the de-quantized encoded data based, at least in part, on pairing values of the de-quantized encoded data with values of de-quantized encoded data of a prior frame, thereby producing a frame of smoothed data, transforming the frame of smoothed data to a frame of time domain data, and appending each frame of time domain data to a prior frame of time domain data, thereby producing frames of time domain data.

According to some embodiments of the invention, the data includes audio data. According to some embodiments of the invention, the codec is a wideband codec, and a width of the data frame is about 10 milliseconds. According to some embodiments of the invention, the codec is a wideband codec, and the audio data is sampled at a frequency of about 16,000 Hz.

According to some embodiments of the invention, if a frame of encoded data is missing from the encoded data frames, a replacement frame of encoded data is produced. According to some embodiments of the invention, if a frame of encoded data is found to contain errors, a corresponding replacement frame of time domain data is produced.

According to some embodiments of the invention, the encoding involves no algorithmic latency. According to some embodiments of the invention, the decoding involves latency of only one frame of encoded data.

According to an aspect of some embodiments of the present invention there is provided circuitry configured to implement the codec scheme.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

Implementation of the method and/or system of embodiments of the invention can involve performing or completing selected tasks manually, automatically, or a combination thereof. Moreover, according to actual instrumentation and equipment of embodiments of the method and/or system of the invention, several selected tasks could be implemented by hardware, by software or by firmware or by a combination thereof using an operating system.

For example, hardware for performing selected tasks according to embodiments of the invention could be implemented as a chip or a circuit. As software, selected tasks according to embodiments of the invention could be implemented as a plurality of software instructions being executed by a computer using any suitable operating system. In an exemplary embodiment of the invention, one or more tasks according to exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well.

### BRIEF DESCRIPTION OF THE DRAWINGS

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 is a simplified flow diagram of a method for encoding digital data according to an example embodiment of the invention;

FIG. 2 is a simplified flow diagram of a method for decoding data, including frames of selected quantized spectral component data produced by the method of FIG. 1, according to an example embodiment of the invention;

FIG. 3 is a simplified block diagram of an encoder for encoding digital data, according to an example embodiment of the invention;

FIG. 4 is a simplified block diagram of a decoder for decoding data including frames of selected quantized spectral component data produced by the apparatus of FIG. 3;

FIG. 5A is a more detailed simplified block diagram of an example embodiment of the encoder of FIG. 3;

FIG. 5B is a simplified graph illustrating weighting windows applied to sampled data in the example embodiment of FIG. 5A;

FIG. 6 is a more detailed simplified block diagram of an example embodiment of the decoder of FIG. 4; and

FIG. 7 is a graphical illustration of a spectrum of a previous frame and a spectrum of a current frame, matched according to the track matching method of the example embodiment of FIG. 6.

### DESCRIPTION OF EXEMPLARY EMBODIMENTS OF THE INVENTION

The present invention, in some embodiments thereof, relates to a method and system for encoding and decoding data for transmission, and more particularly, but not exclusively, to an audio codec.

Before explaining at least one embodiment of the invention in detail, it is to be understood that the invention is not necessarily limited in its application to the details of construction and the arrangement of the components and/or methods set forth in the following description and/or illustrated in the drawings and/or the examples. The invention is capable of other embodiments or of being practiced or carried out in various ways.

Encoding

Some embodiments of the invention include a method for encoding a digital data stream, by splitting the stream into data windows, computing spectral components of each data window, selecting prominent spectral components of each data window, and quantizing the selected spectral components of each data window into coded data frames, thus producing an encoded data stream.

The size of data windows is optionally chosen so that the audio signal is considered stationary over the widow period. Speech is typically considered to be stationary over 20 milliseconds. By way of a non-limiting example, data windows of 10 milliseconds each are sampled from the data stream. The data windows are produced at a rate of 100 data windows per second, providing continuous sampling. If the data were not reconstructed smoothly, the data would be likely to produce artifacts. Such of the artifacts are in the audible range, and might affect quality of a reconstructed audio stream if not smoothed out.

Optionally, the data windows are as small as possible, tempered by a need to get good data representation for most of the time. Good data representation depends on an application of the data. For example, in a case of audio data, the reconstructed audio data should be of acceptable quality to a listener. Having acceptable quality also optionally includes how much of the time the reconstruction should be of good quality.

In an exemplary embodiment of the invention the data windows are optionally as small as possible, thereby avoiding some undesired effects such as pre-echo, yet large enough to enable faithfully capturing the lowest desired speech pitch frequency, optionally most of the time. An optional solution for how to deal with low pitch frequency, which nevertheless occurs some of the time, is provided below.

Optionally, spectral components of the data windows are computed using a Discrete Fourier Transform.

Optionally, the spectral components are computed using other methods, such as the Discrete Cosine transform.

Optionally, other transforms are used.

Optionally, spectral components of the data windows are computed using the digital data stream within each data window, independently of data of the digital data stream external to the window.

Alternatively, the spectral components of a first data window are computed using a second data window which envelops the first data window, and contains more data than the first data window.

Optionally, identifying prominent spectral components of each data window uses the data within each window, independently of data external to the window.

Alternatively, identifying prominent spectral components of a first data window uses a second data window which envelops the first data window, and contains more data than the first data window.

In some embodiments, using a second data window wider than the first data window and containing the first data window enables faithfully capturing lower frequencies than enabled using only the first data window.

Optionally, peak picking, that is selection of some of the prominent spectral components of each data window, is done. Some prominent spectral components are optionally kept, and other spectral components are optionally discarded, thereby reducing data from the window. Such peak picking results in compression of the data.

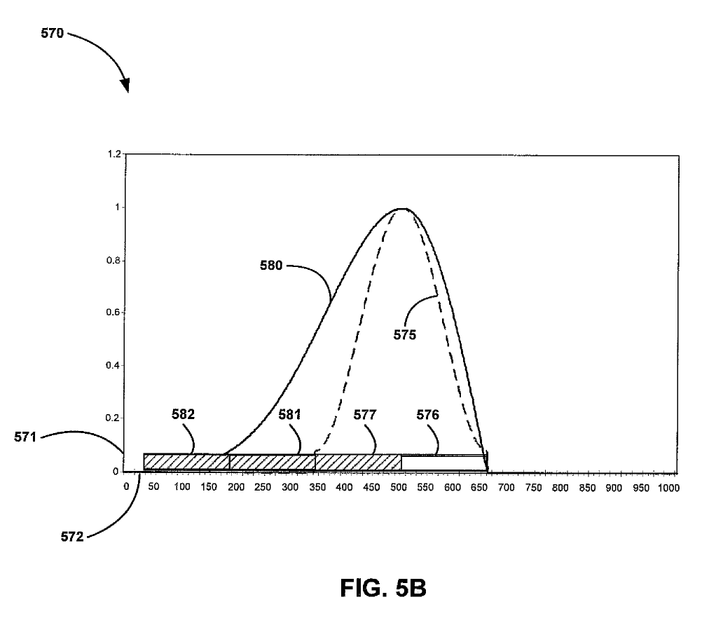

Peak picking is described in more detail below, with reference to FIG. 5A.

It is noted that embodiments of the invention are not necessarily limited to compression of data. The encoding may produce less data than the original data, thereby performing compression. In some embodiments, the encoding may produce encoded data of substantially equal amount to the original data, or sometime even more encoded data than the original data.

It is noted that encoding data which includes compression is often considered advantageous, especially when the data is to be transmitted over a transmission pathway which may be congested.

Optionally, the digital data stream contains audio data. Prominent spectral components of each data window are optionally identified based, at least partly, on a psychoacoustic model. Such a psychoacoustic model is suggested, by way of a non-limiting example, by the above-mentioned Introduction to Digital Audio Coding and Standards, by M. Bosi, and R. E. Goldberg, so that encoding and subsequent decoding of the audio data preserve good sound, as perceived by human listeners. In this context, meaningful encoding is optionally performed in such a way that listeners are not able to hear a difference between original audio signals and audio signals which have been encoded and subsequently decoded. Optionally, it is sufficient that the listeners do not consider the difference to be significantly impairing of the quality of the audio signal. Optionally, when the audio signal contains speech, the encoding is such that quality is impaired, but intelligibility is preserved, and words can be understood. A common metric of quality is Mean Opinion Score (MOS), which is a subjective listening test. An exemplary embodiment of the invention uses a software metric called Perceptual Evaluation of Speech Quality (PESQ)₁ which approximates the MOS score.

Optionally, other uses of embodiments of the present invention include a codec for different types of data, such as, by way of a non-limiting example: fax data; modem data; and monitoring data such as, by way of a non-limiting example, EGG data. Data which can be provided with a model describing important spectral characteristics of the data, similar to the above-mentioned psychoacoustic model, is particularly fitted to being encoded and decoded with embodiments of the present invention. The prominent spectral peaks are optionally selected according to the model appropriate for the type of data. The model optionally includes a typical spectral distribution of the data.

Optionally, quantizing the prominent spectral components is performed independently for each of the amplitude, frequency, and phase of each of the prominent spectral components. The independent quantization of amplitude, frequency and phase is described in more detail below, with reference to the peak picking unit.

Optionally, quantizing of the phase of a specific prominent spectral component is performed with a number of quantizing bits based, at least partly, on the frequency of the specific prominent spectral component and on at least one psychoacoustic criterion.

Given digital data, such as, by way of a non-limiting example, audio data, the data is split sequentially into data windows. Duration of the data windows is optionally equal, although unequal length of data windows is provided in some embodiments of the invention.

Duration of data windows affects a lower limit of spectral frequency which can be faithfully sampled. The lower the frequency to be faithfully reconstructed the longer the window duration. The duration is optionally adapted to the data being encoded.

Duration of data windows is optionally selected to be large enough to capture harmonic behavior.

Duration of data windows is optionally selected so that signal statistics do not change much within a data window, technically termed sufficiently stationary.

Data may be input as a steady stream, and may be input as a sequence of data frames. If the data is in data frame format, a size of the data windows may optionally be equal to a size of the data frames, or an integer multiple thereof, or a fraction thereof. Selecting a suitable size for the data window is described in more detail below, with reference to FIG. 5.

The digital data may be any digital data.

Especially appropriate is data with a repetitive structure, such as audio data, having typical spectral components, and experimental data. By way of a non-limiting example, Electrocardiogram (ECG) data has a typical repetitive structure. Many other data types are repetitive and possess specific spectral characteristics.

The spectral range which is sampled for use in an embodiment of the present invention depends on the application for which the signal is used. Some non-limiting examples include, for speech, a sampling rate of approximately 16 KHz or approximately 22 KHz. For music, a sampling rate of approximately 44.1 KHz is one non-limiting example of a sampling rate, which corresponds to a certain level of musical quality.

In some embodiments of the invention a user may select a bandwidth.

In some embodiments of the invention a user may select whether the codec is configured for speech and/or for music, thereby influencing the spectral range, peak picking, and the psychoacoustic model.

Also appropriate is data without a repetitive structure. One such, non-limiting, example, is unvoiced speech, which is coded with an embodiment of the present invention.

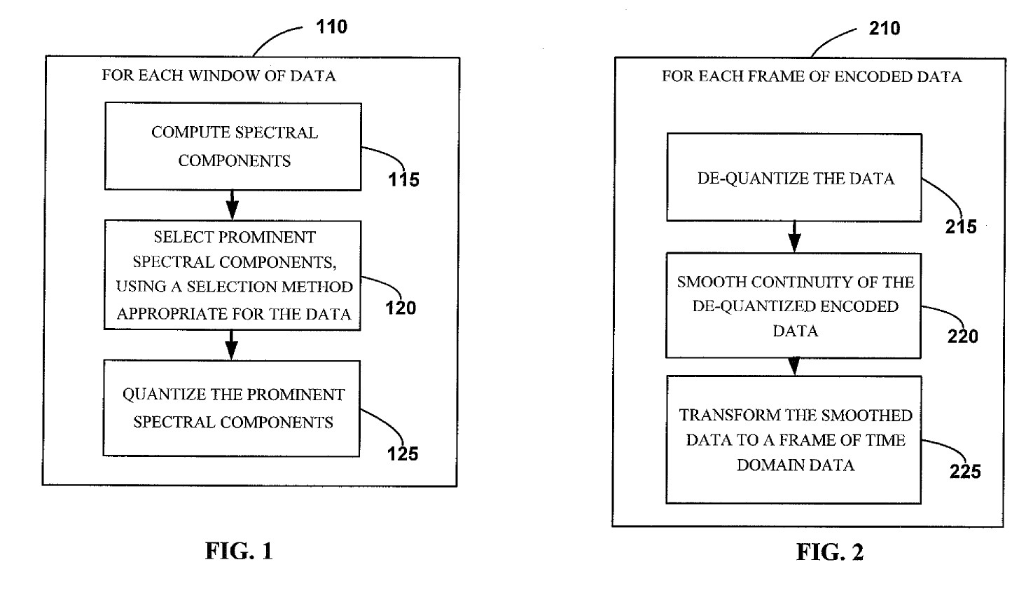

Reference is now made to FIG. 1, which is a simplified flow diagram of a method for encoding digital data according to an example embodiment of the invention.

By way of a non-limiting example, in case of audio data, a window of 10 milliseconds of an audio signal is sampled, optionally at a rate of 16000 Hz. Such a window, sampled at such a rate, produces 160 samples of digital audio data per window.

Processing is performed for each such window of 160 samples (110).

Spectral components of the data in the window are computed (115). The spectral components are optionally computed using a suitable temporal-to-frequency transform. Exemplary embodiments of the computing are described in further detail below, with reference to FIG. 5A.

Prominent spectral components are selected, optionally using a selection method appropriate for the data (120). An exemplary selection method will be described in further detail below, with reference to FIG. 5A.

The prominent spectral components are quantized (125), thereby producing frames of encoded data. The quantizing will be described in further detail below, with reference to FIG. 5A.

The resulting frames of encoded data are sent in order, thereby producing an encoded data frame stream. Physically, packets may be sent by VoIP, and may arrive in a different order. Packets which arrive late, after an allowed buffering time, may be dropped.

It is to be appreciated that in context of the invention, there are cases in which it does not matter whether the encoded data frame stream is transmitted, as is contemplated for some embodiments of the invention, or the encoded data frame stream is otherwise used. The data stream may be, by way of a non-limiting example, stored, as is contemplated for some other embodiments of the invention.

Decoding

Some embodiments of the invention include a method for decoding data including encoded data frames such as produced by the above-mentioned encoding method. In an exemplary embodiment of the invention the decoding is done by de-quantizing each frame, producing de-quantized frames of encoded data, smoothing the encoded data based, at least in part, on comparing values of the de-quantized encoded data with values of de-quantized encoded data of a prior frame, and transforming the smoothed data to a frame of time domain data.

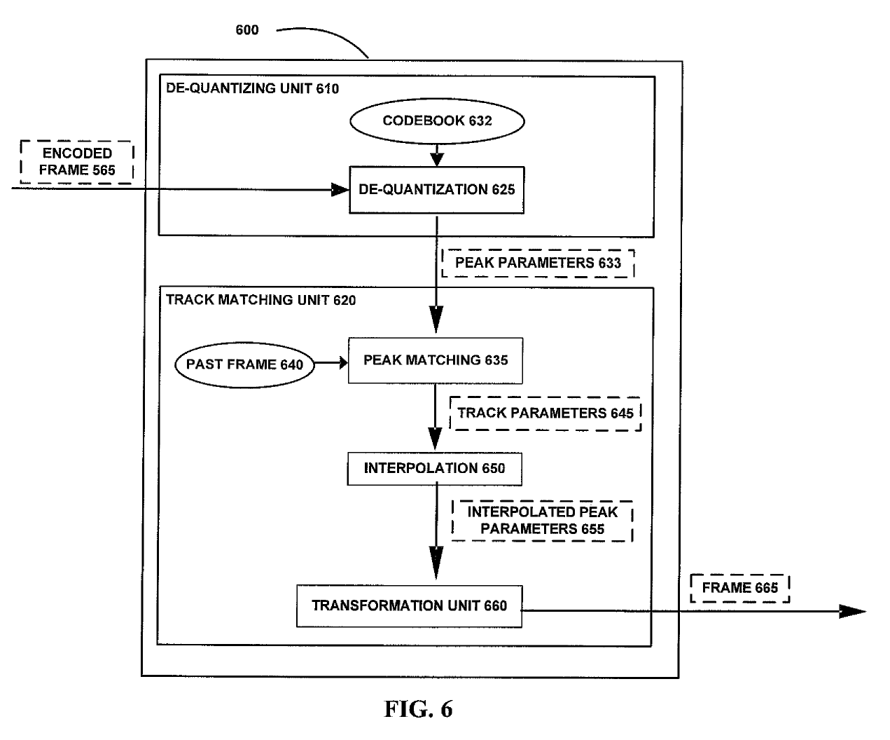

Optionally, the smoothing of the encoded data is performed using a track matching method, as described in more detail below with reference to FIG. 6.

Optionally, the track matching method is performed using a Gale-Shapley method, such as described in the above-mentioned reference College Admissions and the Stability of Marriage, by D. Gale, and L. S. Shapley, published in American Mathematical Monthly 69, 1962. Prominent spectral components of a previous frame are optionally paired with prominent spectral components of a current frame, using the Gale-Shapley method, where components of close frequencies are matched together. Then, optionally, parameters characterizing each pair of components are used to compute track parameters, optionally using a McAuley-Quatieri method.

The decoding method optionally replaces missing encoded data frames. The decoding method also optionally replaces frames which are received late, since in some applications, such as audio, music, voice, a late-arriving frame should not be used, and should optionally be replaced. The decoding method also optionally replaces frames which are received with errors. When a frame is lost, the decoding method optionally automatically generates a replacement for the frame (as described below). Optionally, when a long sequence of frame is lost, by way of a non-limiting example when 100 ms or more are lost, the decoder gradually attenuates the signal and then generates zero-valued frames.

Optionally, when a frame of encoded data is missing or contains errors, a replacement frame of encoded data is optionally produced based, at least in part, on extrapolating values for the replacement frame from the encoded data of the prior frame.

Optionally, when an encoded data frame is missing or contains errors, a replacement frame of encoded data is produced based, at least in part, on interpolating values for the replacement frame from the encoded data of the prior frame and encoded data of a following frame.

Optionally, when an encoded data frame is missing or contains errors, a replacement frame of encoded data is produced based, at least in part, on backward extrapolating values for the replacement frame from encoded data of a following frame.

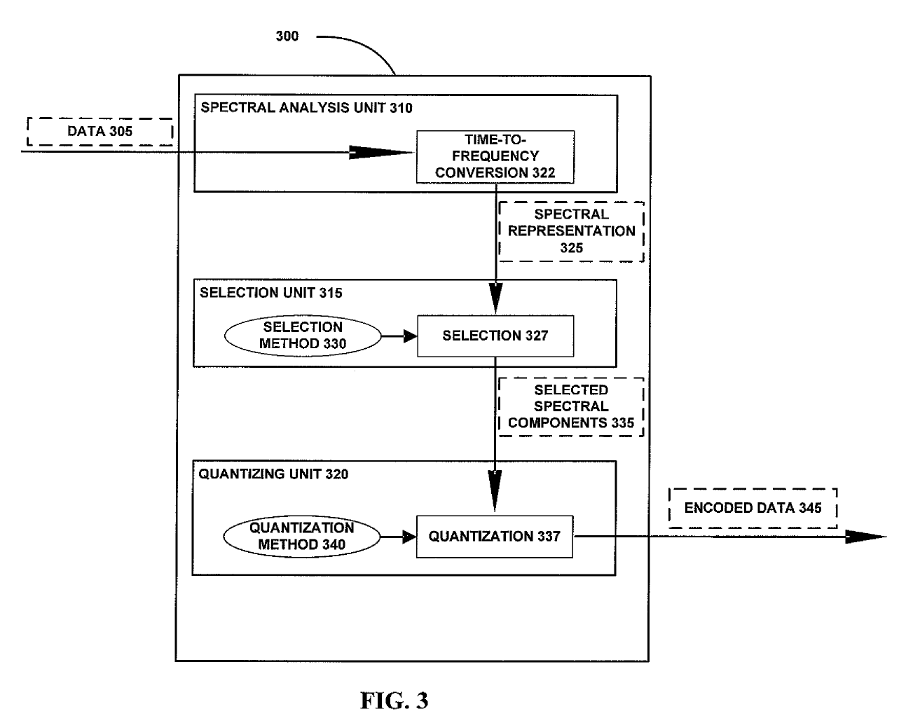

Reference is now made to FIG. 2, which is a simplified flow diagram of a method for decoding data, including frames of selected quantized spectral component data produced by the method of FIG. 1, according to an example embodiment of the invention.

Given data including encoded data frames produced by the above-mentioned encoding method, each such frame is processed as follows (210).

Each frame is de-quantized (215), that is, the encoded data is converted from quantized to de-quantized, producing a frame of de-quantized encoded data. An exemplary de-quantizing method will be described in further detail below, with reference to FIG. 6.

Possibly, the frame of encoded data forms discontinuities with the previous frame of encoded data. Optionally, the data of the frame of encoded data is “smoothed”, to minimize or eliminate the discontinuity (220), thereby producing a frame of smoothed data. The smoothing optionally changes the frame of encoded data, which optionally includes selected prominent spectral peaks, so that the selected prominent spectral peaks conform closely to the selected prominent spectral peaks of the previous frame.

The frame of smoothed data is transformed into a frame of time domain data. The transformation is described in more detail below, with reference to the description of FIG. 6.

Additional embodiments of the invention include apparatus for performing the encoding, apparatus for performing the decoding, circuitry for performing the encoding, circuitry for performing the decoding, and systems for transmission using the encoding and decoding methods.

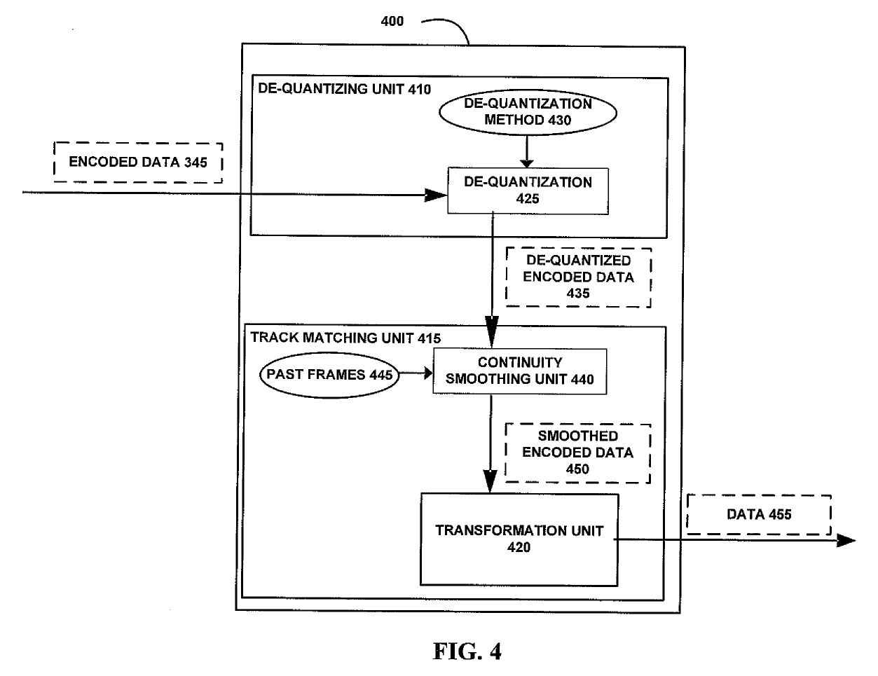

Some of the above-mentioned embodiments will now be described, with reference to FIGS. 3-6.

Reference is now made to FIG. 3, which is a simplified block diagram of an encoder 300 for encoding digital data, according to an example embodiment of the invention.

The apparatus 300 comprises a spectral analysis unit 310, a selection unit 315, and a quantizing unit 320.

The spectral analysis unit 310 accepts input of the data 305, and performs time-domain to frequency-domain conversion 322 on windows of the incoming data 305, producing output of a spectral representation 325 of the data 305.

The size, or time span, of the data windows is optionally selected taking into account frequencies typical of the data, and latency produced by the size of the windows. Selecting the size of the windows will be further described below, with reference to FIG. 5A.

The time-domain to frequency-domain conversion 322 is optionally performed on a window by window basis, separately for each window.

The time-domain to frequency-domain conversion 322 is optionally performed using FFT (Fast Fourier Transform), DCT (Discrete Cosine Transform), or some other transform. It is to be appreciated that the conversion can be performed using software or hardware. Hardware devices which perform the conversion are available, and may be used to perform the conversion. Hardware devices typically perform the conversion faster than software.

Exemplary implementations of time-domain to frequency-domain conversion 322 will be additionally described below, with reference to FIGS. 5A.

The output of the spectral analysis unit 310 is provided as input to the selection unit 315. The selection unit 315 performs a selection 327 of some spectral components from the spectral representation 325, according to a selection method 330, producing output of the selected spectral components 335. The selection 327 is optionally performed on a window by window basis, separately for each window.

The output of the selection unit 315 is provided as input to the quantizing unit 320. The quantizing unit 320 performs quantizing 337 of the selected spectral components 335, according to a quantizing method 340, producing an output of frames of encoded data 345.

It is noted that the encoder 300 does not require any algorithmic latency for its operation, although the encoder 300 may require a buffer of some size, corresponding to a data window size. It is noted that the data window size may change over time, so a buffer of sufficient size is required. There is no need to wait for input of a later window in order to encode and optionally transmit a current window.

The encoder 300 is considered as not requiring any algorithmic latency because once a current frame has been selected for encoding (incurring buffering latency equal to the buffer size), the encoding can proceed with no delay.

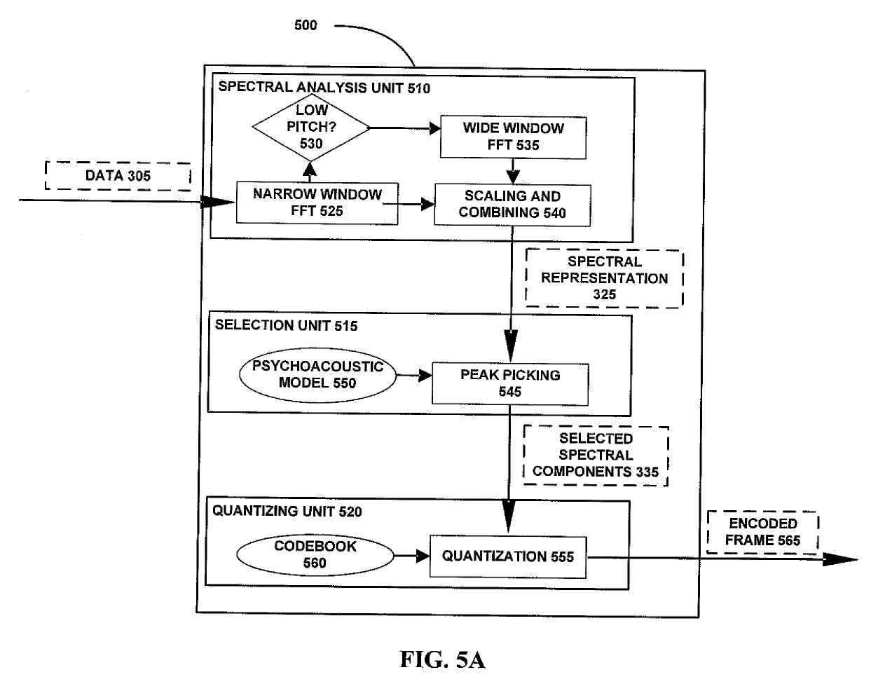

Reference is now made to FIG. 4, which is a simplified block diagram of a decoder 400 for decoding data including frames of selected quantized spectral component data produced by the apparatus of FIG. 3.

The decoder 400 comprises a de-quantizing unit 410, and a track matching unit 415.

The de-quantizing unit 410 accepts input of the encoded data 345 of FIG. 3, and performs de-quantizing 425 on the incoming encoded data 345, producing an output of de-quantized encoded data 435. The de-quantizing 425 is performed according to a suitable de-quantizing method 430.

The de-quantizing 425 is optionally performed on a frame by frame basis.

The de-quantizing 425 is optionally performed in order to recover a good reconstruction of the selected spectral components 335 of FIG. 3. The de-quantizing method 430 will be described in further detail below, with reference to FIG. 6.

The output of the de-quantizing unit 410 is provided as input to the track matching unit 415.

Reconstructing data from the de-quantized representation of the spectral components may result in discontinuity between frames. When the data contains audio data, this may produce unpleasant audible artifacts. Various factors produce the discontinuities between frames, such as quantization errors, the encoding being a lossy encoding, and because data at a frame boundary is optionally reconstructed without reference to values of data of a previous frame.

Optionally, to ensure a smooth transition between frames, the track matching unit 415 is used.

In an exemplary embodiment of the invention, the track matching unit 415 comprises a continuity smoothing unit 440 and a transformation unit 420. The de-quantized encoded data 435 is input to the continuity smoothing unit 440, which produces smoothed encoded data 450 frames based, at least in part, on the de-quantized encoded data 435, and on the de-quantized representation of the selected spectral components of one or more past frames 445.

The smoothed encoded data 450 frames are produced as output of the continuity smoothing unit 440, and provided as input to the transformation unit 420. The transformation unit 420 transforms the spectral component data to time-domain data 455.

The way in which the track matching unit 415 transforms the spectral component data to time-domain data 455 will be further described below with reference to FIG. 6.

The time domain data 455 is output from the decoder 400.

It is noted that the decoder 400 causes an algorithmic latency as short as the frame size. By way of a non-limiting example, as described in more detail below with reference to FIG. 5A, the frame size and latency may be 10 ms.

Reference is now made to FIG. 5A, which is a more detailed simplified block diagram of an example embodiment 500 of the encoder 300 of FIG. 3.

The example embodiment 500 comprises a spectral analysis unit 510, a selection unit 515, and a quantizing unit 520.

In an exemplary embodiment of the invention the spectral analysis unit 510 comprises a narrow window FFT unit 525, a low pitch determining unit 530, a wide window FFT unit 535, and a scaling and combining unit 540.

The spectral analysis unit 510 accepts input 305 (similar to FIG. 3).

The input 305 may be, by way of a non-limiting example, similar to the input described above with reference to FIG. 1, including data windows of 160 samples, each window representing a 10 millisecond interval of an audio signal, sampled at a rate of 16,000 Hz. Exemplary rationale for selecting a window size is presented below, with reference to the structure and function of the spectral analysis unit 510.

It is to be noted that the example implementation of the embodiment 500 is described with reference to the sampling rate of 16,000 Hz and the 10 millisecond frame. However, other sampling rates lower than 16,000 Hz, such as 8,000 Hz, and higher than 16,000 Hz, such as 22 KHz, 44.1 KHz, are similarly supported by alternative embodiments of the invention. Data window sizes suitable for the above-mentioned other sampling rates are similarly supported.

It is to be noted that a codec for speech data sampled at a rate of 16,000 Hz and above, is considered a wideband codec. Being a wideband codec, the invention is also useful for music, which requires a wide range of frequencies to be reproduced. It is noted that quality music may require even higher bandwidth, such as 44.1 KHz, which is reproduced by embodiments of the invention.

The Spectral-Analysis Unit 510

The spectral-analysis unit 510 optionally performs a Discrete Fourier Transform (DFT), using the narrow window FFT unit 525, on the input data 305, in order to find a spectral representation of the data. Relatively few samples are included in the DFT computation, thereby temporally localizing the output and avoiding pre-echo effects. By way of the non-limiting example of FIG. 1, the narrow window FFT unit 525 applies an FFT transform to a window of 320 samples, taken from a current input frame and a previous frame of 160 samples each.

Using a short window may be insufficient in case of a low-pitched sound, such as sound of a low-pitched speaker. As a rule of thumb, an effective window length is usually 2.5 times the pitch period; as described, for example, in the above-mentioned reference: Sinusoidal Coding, by R. J. McAuley, and T. F. Quatieri, which is chapter 4 in W. B. Kleijn and K. K. Paliwal, editors, Speech Coding and Synthesis (pages 121-173). Elsevier Science B.V., 1995.

Considering only 320 samples, namely 20 milliseconds, of speech is therefore sufficient for pitch of approximately 125 Hz or above. The spectral analysis unit 510 uses the low pitch determining unit 530 to estimate pitch for each data window. In case low-pitched data is detected, the spectral analysis unit 510 performs a second DFT based on a wider window of, by way of a non-limiting example, 512 samples, using the wide window FFT unit 535. The spectral analysis unit 510 uses the scaling and combining unit 540 to combine output of the wide window FFT unit 535 with the output of the narrow window FFT unit 525, replacing spectral coefficients which represent frequencies below 1250 Hz which are produced by the narrow window FFT unit 525 with spectral coefficients which represent frequencies below 1250 Hz which are produced by the wide window FFT unit 535.

It is noted that the above-mentioned example of a narrow window using 320 samples from a current and a previous frame for a 20 milliseconds window is optionally changed according to character of the audio signal. By way of a non-limiting example, such a change includes using a shorter window for mode transients in the audio signal, such as drum beats.

It is noted that the wide window FFT unit 535 does not affect latency in the encoder, as was described above with reference to FIG. 3.

The resulting coefficients are scaled so they represent the spectrum of the input frame. The output of the spectral analysis unit 510 is a complex sequence denoted as X₀, X₁, . . . , X_{k/2}, by way of a non-limiting example K=1024, K being an order of the DFT used by the wide window FFT unit 535. The output of the spectral analysis unit 510 corresponds to the spectral representation 325 of FIG. 3. When the output of the spectral analysis unit 510 does not include K/2 values, zero-padding is optionally used so that the DFT accepts a correct number of values.

It is to be noted that the spectral analysis unit 510 can produce a spectral representation 325 according to other coding methods. Any parametric coder may optionally be used, that is, a code based on parameters of a model of the signal, such as a model of speech.

A non-limiting example of another coding method is a vocoder where coding parameters include short time filter coefficients; an indication whether a current frame is voiced, unvoiced, or mixed; and a gain value. The short time filter coefficients may optionally be obtained by Linear Predictive Coding (LCP) analysis.

The FFT produces a sinusoidal coding, so called because it is based on a sine function. Other coding methods, by way of a non-limiting list of examples, include:

cosine coding, optionally implemented by a Discrete Cosine Transform DCT);

applying Linear Predictive Coding (LPC) to input data, and optionally subsequent coding such as sinusoidal coding to the residual;

shaping phase of the input data before subsequent coding such as sinusoidal coding, in order to reduce bit rate of the subsequent coding;

other forms of transform such as, by way of a non-limiting example, wavelet transform, damped sinusoidal transform; and

using an analysis by synthesis iteration to derive parameters describing the input signal.

It is noted that analysis by synthesis is described as an optional method of determining the parameters of a speech encoder, in which the consequence of choosing a particular value of a coder parameter is evaluated by locally decoding the signal and comparing it to the original input signal.

An example embodiment of the spectral analysis unit 510 is now described in more detail. It is noted that the values provided with reference to the example are example values pertaining to a speech signal and the example embodiment of FIG. 5A. Other sets of values may be taken together to apply to other embodiments of the invention and/or other input signals.

The spectral analysis unit 510 accepts input of a frame of speech samples x₀, X₁, . . . , x_{T-1}. By way of a non-limiting example, T=160, and the frame represents 10 milliseconds of speech, sampled at 16000 Hz.

The spectral analysis unit 510 produces output of a sequence of complex coefficients X₀, X₁, . . . , X_{k/2}, such that:

$${x}_{n} = \vert {X}_{0} \vert + 2 \cdot {\sum }_{k = 1}^{K / 2 - 1} \vert {X}_{k} \vert sin ( \begin{matrix}\begin{matrix}\frac{2 π k}{K} \cdot n + \\ arg ( {X}_{k} ) +\end{matrix} \\ {( - 1 )}^{k} \cdot \frac{π}{2}\end{matrix} ) + {( - 1 )}^{n} \vert {A}_{K / 2} \vert \qquad Equation 1$$

where K=1024 is the order of the Fourier transform of the above equation.

The spectral analysis unit 510 considers relatively few samples in a FFT computation, so as to better localize output and avoid pre-echo effects.

Reference is now additionally made to FIG. 5B, which is a simplified graph 570 illustrating weighting windows applied to sampled data in the example embodiment of FIG. 5A.

The graph 570 depicted in FIG. 5B has a Y-axis 571 corresponding to a weighting (multiplication) coefficient applied to the sampled data, and a X-axis 572 corresponding to a series of values of sampled data, having indexes 0 to 1000.

In an exemplary embodiment of the invention, a Hamming window 575 of size 320 samples is applied on a current frame 576 and a previous frame 577. The Hamming window 575 w₀, w₁, . . . , w_{N-1} of size N is given by:

$${w}_{n} = α - ( 1 - α ) \cdot cos \frac{2 π n}{N - 1} \qquad Equation 2$$

In the example embodiment N=320 and α=0.54.

The windowed samples are evenly padded with zeros to assemble a sequence of 1024 samples, and sent to the narrow window FFT 525.

The output of the Fourier transform is a sequence X₀^{(h)}, X₁^{(h)}, . . . , X₁₀₂₃^{(h)} of 1024 complex-valued coefficients. However, as the input to the FFT is a sequence of real values, the output coefficients have a symmetry, and Xₖ^{(h)}= X̅₁̅₀̅₂̅₄̅₋̅ₖ̅^̅{̅(̅h̅)̅}̅ for each 1≦k≦512. It is therefore sufficient to output just half of the coefficients X₀^{(h)}, X₁^{(h)}, . . . , X₅₁₂^{(h)}.

Using a short window may be insufficient in case of a low-pitched speaker. As a rule of thumb, the effective window length should be 2.5 times the pitch period; as described, for example, in the above-mentioned reference: Sinusoidal Coding, by R. J. McAuley, and T. F. Quatieri. Considering only 320 samples, namely 20 milliseconds of speech, is therefore sufficient only for a pitch of 1250 Hz or above. The pitch of each frame is therefore estimated. In case of a high pitch, the spectral-analysis module outputs the FFT coefficients: X₀=c^{(h)}·X₀^{(h)}, X₁=c^{(h)}·X₁^{(h)}, . . . , X₅₁₂=c^{(h)}·X₅₁₂^{(h)}, where c^{(h)}=3.6094 is a scaling factor that compensates for a gain loss incurred by the Hamming window.

In case the pitch estimate falls below 125 Hz, an asymmetric Gaussian-cosine window 580 of size 512 is applied to the current frame 576 and its predecessor frames 577 581 582; in such a case three predecessor frames 577 581 582 are considered, as shown in FIG. 5B. The Gaussian-cosine window w₀, w₁, . . . , w_{N-1} of size N is given by:

$${w}_{n} = \{ \begin{matrix}exp ( \frac{n - G + \frac{1}{2}}{σ \cdot ( G + \frac{1}{2} )} ) & 0 \leq n < G \\ cos \frac{π n}{2 ( N - G ) - 1} & G \leq n < N\end{matrix} \qquad Equation 3$$

Example values for the Gaussian-cosine window 580 are N=512, G=320, and a σ=0.4. The beginning of the current frame 576 is optionally placed at the center of the FFT, and an uneven zero-padding is applied on the windowed frames 576 577 581 582 before sending the windowed frames 576 577 581 582 to the wide window FFT 535. The output of the wide window FFT 535 is denoted X₀^{(l)}, X₁^{(l)}, . . . , X₅₁₂^{(l)}. When a frame sample is placed at a center of an FFT window rather than at a start of the FFT window, the zero-padding is termed uneven zero-padding.

The output of the spectral-analysis unit 510 is given by:

X₀=c^{(l)}·X₀^{(l)}, . . . , X₇₉=c^{(l)}·X₇₉^{(l)}, X₈₀=c^{(h)}·X₈₀^{(h)}, . . . , X₅₁₂c=^{(h)}·X₅₁₂^{(h)} Equation 4

where c^{(l)}=2.4373 is a scaling factor which compensates for a gain loss incurred by the Gaussian-cosine window. Namely, the first 80 coefficients, which represent a frequency range up to 1250 Hz, are taken on a basis of the wide analysis window, and the rest of the coefficients are based on the narrower analysis window.

The Selection Unit 515

The selection unit 515 comprises a peak picking unit 545 and optionally a psychoacoustic model 550. The psychoacoustic model 550 is optionally be hardwired into the peak picking unit 545

Given a spectral representation 325 of a data window, the selection unit 515 uses the peak picking unit 545 to select a sequence of perceptually significant spectral peaks, where an iₜₕ peak [symbol] Âᵢ, \hat{ω}ᵢ, \hat{φ}ᵢ [symbol] is characterized by amplitude, frequency, and phase. Perceptually significant means that a sequence given by:

$${\tilde{x}}_{n} = {\sum }_{i = 1}^{M} {\hat{A}}_{i} \cdot sin ( {\hat{ω}}_{i} \cdot n + {\hat{φ}}_{i} )$$

closely approximates an original window x₀, x₁, . . . , x_{T-1}, with hardly any audible differences.

The peak picking unit 545 optionally selects a maximum of, by way of a non-limiting example, 40 spectral peaks. Thus, M≦40 in the equation above.

In general, more spectral peaks provide better quality, yet add bits to a representation. M=˜40 has been found experimentally to serve well for speech.

The peak picking unit 545 receives the spectral peaks, for example the Fourier coefficients which represent sinusoidal components in the input. A coefficient is considered as a potential peak if its magnitude is larger than both its neighbors, namely if |Xₖ₋₁|<|Xₖ| and |Xₖ|>|Xₖ₊₁|. However, in order to reduce the number of peaks, the selection unit 515 optionally applies psychoacoustic criteria from the psychoacoustic model 550 to identify the most prominent peaks. Psychoacoustic criteria are described, by way of a non-limiting example, in the references described above: Introduction to Digital Audio Coding and Standards, by M. Bosi, and R. E. Goldberg, Springer, 2002; and Psychoacoustics: Facts and Models, by E. Zwicker and H. Fastl, Springer-Verlag, 1990.

Reducing the number of peaks is described in more detail below, with reference to peak picking unit 545.

The psychoacoustic criteria are input into the peak picking unit 545 from the psychoacoustic model 550.

Some embodiments of the invention use psychoacoustic criteria described in the above-mentioned Psychoacoustics: Facts and Models reference.

The psychoacoustic criteria are optionally tailored for speech, or alternatively optionally tailored for music.

The selection of spectral peaks is optionally done in an iterative manner. During each iteration, a most prominent spectral peak is selected. A masking which the selected spectral peak induced on surrounding frequencies is computed, optionally affecting prominence of the surrounding frequency peaks, and a subsequent spectral peak is selected optionally based on unmasked spectral representation data.

The output of the selection unit 515 comprises selected spectral peaks, which correspond to the selected spectral components 335 of FIG. 3.

It is noted that the psychoacoustic model 550 is optionally different for each type of spectral representation. By way of a non-limiting example, with reference to the list of optional spectral representations above, the psychoacoustic model 550 of a sinusoidal transform is different than the psychoacoustic model 550 of a wavelet transform.

The Peak Picking Unit 545

An example embodiment of the peak picking unit 545 is now described in more detail. It is noted that the values provided with reference to the example are example values pertaining to a speech signal and the example embodiment of FIG. 5A. Other sets of values may be taken together to apply to other embodiments of the invention and/or other input signals.

The peak picking unit 545 accepts input of a sequence of complex coefficients X₀, X₁, . . . , X_{k/2} which is an output of the spectral-analysis unit 510.

The peak picking unit 545 produces output of a sequence of perceptually significant spectral peaks, where an iₜₕ peak [symbol] Âᵢ, \hat{ω}ᵢ, \hat{φ}ᵢ [symbol] is characterized by its amplitude, its frequency and its phase. By perceptually significant it is meant that a sequence given by:

$${\tilde{x}}_{n} = {\sum }_{i = 1}^{M} {\hat{A}}_{i} \cdot sin ( {\hat{ω}}_{i} \cdot n + {\hat{φ}}_{i} ) \qquad Equation 5$$

closely approximates an original frame x₀, x₁, . . . , x_{T-1}, with hardly any audible differences. For the present example case we use a maximum of 40 peaks, thus M≦40 in equation 5 above.

The peak-picking unit 545 starts by identifying spectral peaks, for example Fourier coefficients which represent sinusoidal components in the signal. A coefficient is considered as a potential peak if its magnitude is larger than both its neighbors, namely if |Xₖ₋₁|<|Xₖ| and |Xₖ|>|Xₖ₊₁|.

A sound pressure level (SPL) associated with the peak is given by:

Lₖ=96+10 ·log₁₀(|Xₖ₋₁|²+|Xₖ|²|+Xₖ₊₁|²) Equation 6

A kₜₕ Fourier coefficient represents a frequency

$${f}_{k} = \frac{k}{K} \cdot {F}_{s} ,$$

where Fₛ is the sampling rate. In our example Fₛ=16000 Hz and K=1024, each coefficient represents a frequency bin of 15.625 Hz. As the peak picking unit 545 applies psychoacoustic criteria, as described in the above-mentioned reference Psychoacoustics: Facts and Models in order to select most perceptually significant peaks, the peak picking unit 545 converts a frequency of each peak to a Bark scale, where:

$${z}_{k} = 13 \cdot arctan ( 0.76 \cdot {f}_{k} ) + 3.5 \cdot arctan ( {( \frac{{f}_{k}}{7.5} )}^{2} ) \qquad Equation 7$$

In which fₖ is measured in kHz.

An absolute hearing threshold (AHT) is associated with each peak. Roughly speaking, if Lₖ<AHTₖ, then a specific frequency cannot be heard by an average human listener. Initially, AHTₖ equals a Threshold In Quiet (TIQ) of a peak, and is given by:

TIQₖ=3.64fₖ^{-0.8}−6.5·e^{-0.6(f}^{ₖ}^{-3.3)}^{²}+10⁻³·fₖ⁴ Equation 8

In which fₖ is again measured in kHz.

However, the hearing threshold may increase due to a masking effect. Namely, a loud sound with some frequency f may prevent a human ear from detecting other sounds of nearby frequencies. Therefore the ISO/IEC psychoacoustic model mentioned in above-mentioned Introduction to Digital Audio Coding and Standards, is used.

Initially, all peaks are marked as unselected. Then, the following procedure is applied, as long as valid peaks remain, and at most (M−5) times, where M=40 is the maximal number of peaks allowed in the output:

(a) Locate a most prominent peak which is still unselected, namely find an index k* where L_{k*}−AHT_{k*} is maximal, and mark the peak as selected.

(b) Go over all unselected peaks. For each peak j let Δz=z_{k*}−zⱼ. A mask mⱼ which the selected peak k* induces on a masked peak j is given by:

$$\begin{matrix}B ( Δ z ) \{ \begin{matrix}\begin{matrix}( 6 + 0.4 \cdot {L}_{{k}^{*}} ) \cdot Δ z + \\ ( 11 - 0.4 \cdot {L}_{{k}^{*}} ) \cdot ( 1 + Δ z )\end{matrix} & Δ z < - 1 \\ ( 6 + 0.4 \cdot {L}_{{k}^{*}} ) \cdot Δ z & - 1 \leq Δ z < 0 \\ - 17 \cdot Δ z & 0 \leq Δ z \leq 1 \\ - 17 \cdot Δ z + 0.15 \cdot {L}_{{k}^{*}} \cdot ( Δ z - 1 ) & 1 < Δ z\end{matrix} \\ and & Equation 9 \\ {m}_{j} = B ( Δ z ) + {L}_{{k}^{*}} - 6.025 - 0.275 \cdot {z}_{{k}^{*}} & Equation 10\end{matrix}$$

The absolute hearing threshold of the masked peak is optionally updated as follows:

AHTⱼ←10·log₁₀(10^{0.1·AHT}^{ⱼ}+10^{0.1·m}^{ⱼ}) Equation 11

The five last peaks are selected based on their sound pressure level. Namely, the peak picking unit 545 selects the five remaining peaks whose Lₖ is maximal.

Having selected the most prominent peaks, the peak picking unit 545 now estimates an amplitude, frequency and phase of the sinusoidal component which each peak represents.

Taking a kₜₕ Fourier coefficient to represent an iₜₕ output peak, in order to compensate for gain losses (amplitude) introduced by the FFT, the peak picking unit 545 also considers energy in the neighboring frequency bins when estimating the amplitude of the sinusoid:

Âₗ=\sqrt{|Xₖ₋₁|²+|Xₖ|²+|Xₖ₊₁|²} Equation 12

In order to have a fine resolution in frequency, the peak picking unit 545 considers non-integer multiplicands of frequency bin-size. The peak picking unit 545 interpolates a parabola through energy values |Xₖ₋₁|², |X|² and |Xₖ₊₁|², and locates an apex of this parabola. The peak picking unit 545 computes:

$${p}_{k} = \frac{{\vert {X}_{k + 1} \vert}^{2} - {\vert {X}_{k - 1} \vert}^{2}}{2 \cdot [ 2 \cdot {\vert {X}_{k} \vert}^{2} - ( {\vert {X}_{k - 1} \vert}^{2} + {\vert {X}_{k + 1} \vert}^{2} ) ]} \qquad Equation 13$$

where −0.5<pₖ<0.5.

A normalized frequency of the sinusoid is given by:

$${\hat{ω}}_{i} = \frac{2 π}{N} ( k + {p}_{k} ) . \qquad Equation 14$$

A phase is computed based on arguments of the Fourier coefficients, namely angles provided by

$${φ}_{k} = arg ( {X}_{k} ) + {( - 1 )}_{\frac{π}{2}}^{k} .$$

An output phase \hat{φ}ᵢ is calculated using a linear interpolation between φₖ₋₁ and φₖ in case if pₖ<0, or between φₖ and φₖ₊₁ if pₖ>0.

The Quantizing Unit 520

The quantizing unit 520 accepts the output of the selection unit 515 as input.

The quantizing unit 520 performs quantizing 555 using a codebook 560 which is comprised in the quantizing unit 520.

In some embodiments of the invention the codebook 560 is hardwired and fixed.

The representation of a data window as a sum of spectrally significant frequencies [symbol] Âᵢ, \hat{ω}ᵢ, \hat{φ}ᵢ [symbol] is optionally compressed even more. The quantizing unit 520 encodes the representation, optionally by considering the three vectors of amplitudes, frequencies and phases, independently.

The vector of amplitudes is optionally encoded using the codebook 560. The codebook 560 is optionally a multi-stage codebook. Deviations from the codebook 560 are produced, optionally using Huffman coding. The vector of frequencies is optionally encoded using similar principles. The vector of phases is optionally encoded using scalar quantizing for each component, where the number of quantizing bits is optionally determined using psychoacoustic criteria.

The operation of the quantizing module on a data window is optionally independent of surrounding windows. Thus, a loss of a data window during transmission does not affect the quality of reconstruction of surrounding data windows.

The quantizing unit 520 produces output of encoded data frames 565.

It is noted that since the encoder 300 encodes prominent spectral components, it is possible to combine the encoding with other acoustic processing methods, such as, by way of a non-limiting example, noise suppression, acoustic echo cancellation, which operate in the frequency domain.

The above combination is optionally performed between the spectral analysis unit 510, and the selection unit 515, on the spectral representation 325.

The above combination may optionally be performed between the selection unit 515 and the quantizing unit 520, on the selected spectral components 335.

An example embodiment of the quantizing unit 520 is now described in more detail. It is noted that the values provided with reference to the example are example values pertaining to a speech signal and the example embodiment of FIG. 5A. Other sets of values may be taken together to apply to other embodiments of the invention and/or other input signals.

The quantizing unit 520 accepts input of a sequence { [symbol] Âᵢ, \hat{ω}ᵢ, \hat{φ}ᵢ [symbol] }ᵢ₋₁^{M} of spectral peaks which represent a current frame, where M≦40.

The quantizing unit 520 produces output of a bit-vector B=b₀b₁ . . . b_{L} encoding the spectral peaks. The length L of the bit-vector may vary.

Representation of a frame as a sum of sinusoids [symbol] Âᵢ, \hat{ω}ᵢ, \hat{φ}ᵢ [symbol] is typically too bit-consuming. The quantizing unit 520 compresses the representation by considering three vectors, of amplitudes, frequencies and phases, independently.

The vector of amplitudes is encoded using the multi-stage codebook 560. Deviations from the codebook 560 are optionally provided efficiently using Huffman coding.

The vector of frequencies is encoded using similar principles.

For the vector of phases the quantizing unit 520 uses scalar quantization of each component, where the number of quantization bits is determined using psychoacoustic criteria.

In exemplary embodiments of the invention the operation of the quantizing unit 520 on a frame is independent of surrounding frames. Thus, a loss of a single frame during transmission does not affect the quality of the surrounding frames.

Reference is now made to FIG. 6, which is a more detailed simplified block diagram of an example embodiment 600 of the decoder 400 of FIG. 4.

The example embodiment 600 comprises a de-quantizing unit 610 and a track matching unit 620. The track matching unit 620 of FIG. 6 corresponds to the track matching unit 415 of FIG. 4.

The de-quantizing unit 610 of the example embodiment 600 accepts input of encoded data frames 565 corresponding to the encoded data frames 565 produced by the embodiment 500 of FIG. 5A. The de-quantizing unit 610 de-quantizes the input bit-stream, that is, converts encoded data frames 565 into a sequence of peak parameters [symbol] Âᵢ, \hat{ω}ᵢ, \hat{φ}ᵢ [symbol] representing the spectrum of the encoded data frames 565.

The track matching unit 620 accepts a pair of peak sequences, representing contiguous frames, a current frame and a previous frame, and reconstructs data frames by interpolating the peak parameters.

The De-Quantizing Unit 610

An example embodiment of the de-quantizing unit 610 is now described in more detail. It is noted that the values provided with reference to the example are example values pertaining to a speech signal and the example embodiment of FIG. 5A. Other sets of values may be taken together to apply to other embodiments of the invention and/or other input signals.

The de-quantizing unit 610 accepts input of a bit-vector B=b₀b₁ . . . b_{L} encoding a current frame.

The de-quantizing unit 610 produces an output of a sequence [symbol] Âᵢ, \hat{ω}ᵢ, \hat{φ}ᵢ [symbol] of spectral peaks, which represent a current frame, where M≦40.

The de-quantizing unit 610 performs a de-quantization 625 according to a codebook 632 comprised in the de-quantizing unit 610. The de-quantization 625 converts an input to a sequence of spectral peak parameters 633 [symbol] Âᵢ, \hat{ω}ᵢ, \hat{φ}ᵢ [symbol] which represent a spectrum of an input frame. The spectral peak parameters 633 are output of the de-quantizing unit 610, and input into the track matching unit 620.

The Track Matching Unit 620

Given a sequence of spectral peaks, it is possible to apply an inverse transform, such as inverse Fourier transform, in order to reconstruct an approximation of the frame in the time domain.

Reconstruction of a data frame by using inverse DFT often forms discontinuities with a previous frame. When the data frame contains audio data, the discontinuities can result in unpleasant audible artifacts.

Optionally, in order to smooth a transition between frames, the track matching unit 620 computes spectral peak parameters for a current frame based, at least partly, on spectral peaks of a neighboring previous frame.

The computing is optionally done by applying a track matching method similar to, by way of a non-limiting example, the Gale-Shapely algorithm described in the above-mentioned reference College Admissions and the Stability of Marriage, by D. Gale, and L. S. Shapley, published in American Mathematical Monthly 69, 1962.

Generally, the track matching method pairs spectral peak parameters from the current frame with spectral peak parameters from the neighboring previous frame. Since possibly not all the peaks of the current frame are present in the previous frame, the matching produces a best set of pairs.

Track matching is a method used to pair peaks from the neighboring previous frame to peaks in the current frame, then interpolate between each pair of matched peaks, forming a track. A track is represented by coefficients of an amplitude polynomial Ã(t) and a phase polynomial \tilde{φ}(t), the former being a linear polynomial and the latter a cubic polynomial. A detailed description of the computation of the coefficients of these polynomials is described, for example, in the above-mentioned reference Speech Analysis/Synthesis Based on a Sinusoidal Representation, by R. J. McAuley, and T. F. Quatieri, published in IEEE Trans. Acoustics, Speech, and Signal Processing ASSP-34(4), August 1986.

A peak matching unit 635 in the track matching unit 620 accepts the spectral peak parameters 633, and optionally uses the spectral peak parameters 640 of a past frame 640 to match spectral peaks, producing track parameters 645.

The track parameters 645 are transferred to an interpolation unit 650, which interpolates between matched pairs of spectral peaks, producing interpolated peak parameters 655.

After interpolating between the previous and the current frame and computing the track parameters [symbol] Ã₁, \tilde{φ}₁ [symbol] , . . . , [symbol] Ã_{L}, \tilde{φ}_{L} [symbol] , the interpolation unit 650 sends the interpolated peak parameters 655 as input to a transformation unit 660.

The transformation unit 660 transforms the interpolated peak parameters 655 to time domain data, also termed a time-domain signal. In the example embodiment depicted in FIG. 6, the transformation unit 660 reconstructs a decoded frame by summing the tracks over each sample:

$${y}_{n} = {\sum }_{i = 1}^{L} {\tilde{A}}_{i} ( n ) \cdot sin ( {\tilde{φ}}_{i} ( n ) )$$

The transformation unit 660 produces output of a frame 665. The frame 665 is the output of the track matching unit 620, and of the example embodiment 600.

An alternative embodiment of the transformation unit 660 performs an inverse DFT on the interpolated peak parameters 655, thereby transforming the interpolated peak parameters 655, which include frequency domain data, to time domain data.

It is noted that other transformations are also contemplated with respect to the transformation unit 660, such as, by way of a non-limiting example, inverse DCT.

An example embodiment of the track matching unit 620 is now described in more detail. It is noted that the values provided with reference to the example are example values pertaining to a speech signal and the example embodiment of FIG. 5A. Other sets of values may be taken together to apply to other embodiments of the invention and/or other input signals.

The track matching unit 620 accepts input of spectral peaks { [symbol] Âᵢ⁽⁰⁾, \hat{ω}ᵢ⁽⁰⁾, \hat{φ}ᵢ⁽⁰⁾ [symbol] }ᵢ₌₁^{M}^{₀} representing a previous frame, and a sequence of spectral peaks { [symbol] Âᵢ⁽⁺⁾, \hat{ω}ᵢ⁽⁺⁾, \hat{φ}ᵢ⁽⁺⁾ [symbol] }ᵢ₌₁^{M}^{₊} representing a current frame, where M₀, M₊≦40. The spectral peak parameters are measured at times separated by T samples from one another (typically T=160).

The track matching unit 620 produces an output of a reconstructed sequence of samples y₀, y₁, . . . , y_{T-1} that is as similar as possible to an original frame.

Given a sequence of spectral peaks, it is possible to apply an inverse Fourier transform in order to reconstruct a current frame in the time domain. However, such a reconstruction may form discontinuities with a previous frame, resulting in unpleasant audible artifacts. To ensure a smooth transition between frames, the track matching unit 620 is used. The track matching unit 620 receives input of spectral peaks of the previous frame, and constructs track parameters for the current frame. This is done by applying the Gale-Shapely method of the above-mentioned College Admissions and the Stability of Marriage to match peaks from the previous frame to peaks in the current frame, then interpolating between each pair of matched peaks, which form a track. A track is represented by coefficients of an amplitude polynomial Ã(t) and a phase polynomial \tilde{φ}(t), the former being a linear polynomial and the latter a cubic polynomial. Above-mentioned Speech Analysis/Synthesis Based on a Sinusoidal Representation describes the computation of the coefficients of these polynomials.

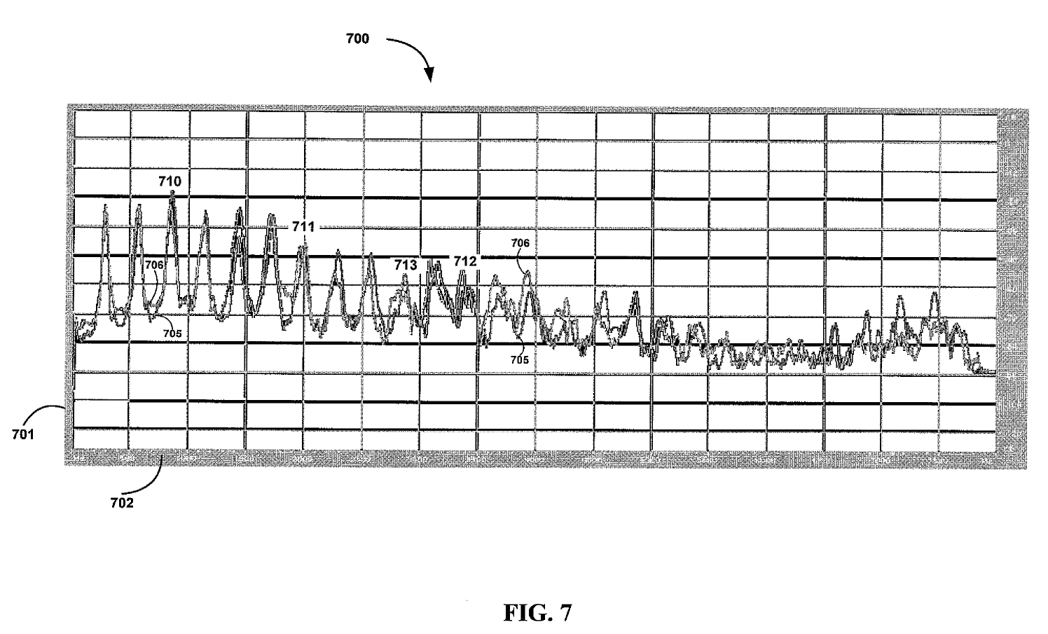

Reference is now additionally made to FIG. 7, which is a graphical illustration of a spectrum of a previous frame 705 and a spectrum of a current frame 706, matched according to the track matching method of the example embodiment of FIG. 6.

FIG. 7 depicts a graph 700 with a Y-axis 701 showing signal amplitude on a relative scale, and an X-axis showing signal frequency, in Hz, from 0 Hz to 8000 Hz.

Two spectrums are depicted, a spectrum of a previous frame 705 and a spectrum of a current frame 706. Both frames are sampled from a speech signal, and both frames are voiced.

A first location 710 in the graph 700 depicts two spectral peaks of the spectrum of the previous frame 705 and the spectrum of the current frame 706, which are matched

A second location 711 in the graph 700 depicts two spectral peaks which are matched, as they represent close, but nor identical, spectral peaks.

A third location 712 in the graph 700 depicts a peak from the spectrum of the previous frame 705 left unmatched, resulting in a “dead” track, which does not have a matching peak in the spectrum of the current frame 706.

A fourth location 713 in the graph 700 depicts a peak in the spectrum of the current frame 706 left unmatched, resulting in a “newly born” track

First described is a case where a peak [symbol] Â₀, \hat{ω}₀, \hat{φ}₀ [symbol] from the spectrum of the previous frame 705 and a peak [symbol] Â₊, \hat{ω}₊, \hat{φ}₊ [symbol] from the spectrum of the current frame 706 are matched and form a track. Such a case corresponds to that depicted in the first location 710 and the second location 711. It is noted that in case of a “dead” track, corresponding to the third location 712, the track matching unit 620 sets [symbol] Â₊=Â₀, \hat{ω}₀, \hat{φ}₊=\hat{φ}₀+\hat{ω}₀·T [symbol] , and in case of a “born” track, corresponding to the fourth location 713 the track matching unit 620 sets [symbol] Â₀=Â₊, \hat{ω}₀=\hat{ω}₀=\hat{ω}₊, \hat{φ}₀=\hat{φ}₊−\hat{ω}₊·T [symbol] .

Continuity of amplitude is achieved by simple linear interpolation:

\tilde{A}(n)=a₀a₁·n Equation 15

where:

$${a}_{0} = {\hat{A}}_{0} , \\ {a}_{1} = ( {\hat{A}}_{+} - {\hat{A}}_{0} ) \cdot \frac{1}{T} .$$

The interpolated phase function is given as a polynomial of degree 3:

\tilde{φ}(n)=c₀+c₁·n+c₂·n²+c₃·n³ Equation 16

where:

$${c}_{0} = {\hat{φ}}_{0} , \\ {c}_{1} = {\hat{ω}}_{0} , \\ {c}_{2} = ( {\hat{φ}}_{+} - {\hat{φ}}_{0} - \hat{ω} \cdot T + 2 π {M}_{c} ) \cdot \frac{3}{{T}^{2}} - ( {\hat{ω}}_{+} - {\hat{ω}}_{0} ) \cdot \frac{1}{T} , \\ {c}_{3} = - ( {\hat{φ}}_{+} - {\hat{φ}}_{0} - {\hat{ω}}_{0} \cdot T + 2 π {M}_{c} ) \cdot \frac{2}{{T}^{3}} + ( {\hat{ω}}_{+} - {\hat{ω}}_{0} ) \cdot \frac{1}{{T}^{2}} .$$

The value of M_{c} is chosen such that \tilde{φ}(n) is a maximally smooth function, that is, the value of ∫₀^{2′}(\tilde{φ}″(t))²dt is minimized:

$${M}_{c} = ⌊ \frac{1}{2 π} ( ( {φ}_{0} + {\hat{ω}}_{0} \cdot T - {φ}_{+} ) + ( {\hat{ω}}_{+} - {\hat{ω}}_{0} ) \cdot \frac{T}{2} ) + \frac{1}{2} ⌋ \qquad Equation 17$$

After interpolating tracks [symbol] Ã₁, \tilde{φ}₁ [symbol] , . . . , [symbol] Ã_{L}, \tilde{φ}_{L} [symbol] , the previous frame can be reconstructed by summing the tracks over each sample:

$${y}_{n} = {\sum }_{i = 1}^{L} {\tilde{A}}_{i} ( n ) \cdot sin ( {\tilde{φ}}_{i} ( n ) ) \qquad Equation 18$$

Packet Loss Concealment (PLC)

Packet loss causes loss of data. Jitter causes data to arrive too late to be used. In both cases a PLC scheme makes up for missing or too-late data. Jitter is typical of some applications, such as Voice over IP (VoIP).

Embodiments of the invention optionally package encoded data frames in transmission data packets. Any number of encoded data frames can optionally be packaged in a transmission packet.

Some embodiments of the invention optionally package one encoded data frame per transmission data packet. Packaging one encoded data frame per transmission data packet provides an advantage that when and if the transmission data packet is lost, exactly one encoded data frame is lost.

Some embodiments of the invention optionally include transmitting encoded data frames using the User Datagram Protocol (UDP).

The PLC mechanism is hereby explained assuming one encoded data frame per transmission packet. The mechanism may be extrapolated according to the description below when a different number of encoded data frames are packages per transmission packet.

It is noted that in case a first, current, frame is lost in transmission, or significantly delayed, a decoder, such as the example embodiment 600, optionally takes the following actions:

(a) continues with the previously calculated track parameters of a second, previous, frame, and extrapolates values of y_{T}, y_{T+1}, . . . , y_{2T-1}.

(b) if a third, next, frame is available, the track matching unit 620 interpolates between peaks of the second, previous frame and the third, next, frame, with an interval of 2T samples. The track matching unit 620 thus decodes the third, next, frame, and at the same time compensates for the loss of the first, current, frame.

If more then one contiguous frames are missing, (a) above is optionally extended, that is, the decoder extrapolates values of the more than one contiguous missing frames.

If one or more future frames, not necessarily consecutive, are received, the track matching unit 620 interpolates between peaks of the previous frame and the future frames.

If new data pertaining to a current frame arrives while the current replacement frame is being played back, the track matching unit 620 produces a new current frame taking into account the new data, and switches to playing back the new current frame, from a point in time within the new current frame corresponding to the switching point. Thus the track matching unit 620 performs PLC even at a sub-frame level.

It is noted that in exemplary embodiments of the invention track matching unit 620 is enabled to optionally produce a replacement encoded data frame, decode the data and optionally start playing the data out, and then, if a new encoded data frame arrives, use the new encoded data frame to correct the played out data frame instantly, thereby correcting the play out in mid-frame. The track matching unit produces a first data frame using one or more encoded data frames for extrapolation and/or interpolation, then produces a second data frame using one or more possibly different encoded data frames. The smooth tracking ability avoids producing artifacts during sub-frame corrections.

In general, sequences of frames with some gaps in between are optionally interpolated/or extrapolated, up to some acceptable overall latency.

Furthermore, if a next frame is received while a previous, interpolated frame is being played back, the decoder optionally immediately and smoothly corrects the playback, without waiting for a currently playing back frame to complete.

The track matching unit 620 (FIG. 6) keeps track of a number K of consecutively lost frames. If K>1, the track matching unit 620 attenuates the amplitude of each track by (10−K)/10. In case of a long sequence of lost frames the signal is gradually attenuated to zero. If M>10 the track matching unit 620 generates a frame of zeros.

The formulae described above with reference to FIG. 7 and to the track matching unit 620 apply in case of packet loss, except that optionally 2T samples are generated by the track matching unit 620 to “bridge” between a previous and a next frame, as described in (b) above.

In some embodiments of the invention PLC is optionally achieved by extrapolation from prior data frames. The embodiments provide minimal latency.

In some embodiments of the invention PLC is optionally achieved by interpolation between one or more prior data frames and one or more “future” data frames to produce a current frame. The buffer storing the frames is referred to as a jitter buffer. Optionally, the jitter buffer is a dynamic jitter buffer, having a size which changes over time.

It is noted that a longer frame is optionally produced, by using, by way of a non-limiting example, 1.2T instead of T. Likewise a shorter frame is optionally produced, by using, by way of a non-limiting example, 0.8T instead of T.

In some embodiments of the invention the jitter buffer is used as a jitter buffer, as described above, even without PLC.

By way of a non-limiting example, if a packet loss rate is above a specified limit, the size of the jitter buffer is optionally increased, by interpolating with 1.2T, over 5 consecutive frames. By way of a non-limiting example, 60 ms of signal are generated from 5 frames of 10 MS each. The example shows how the size of the jitter buffer has been smoothly increased by 10 ms! The interpolation is optionally repeated as needed.

Similarly, if a current jitter buffer size is too large, by interpolating with 0.8T over 5 consecutive frames, the jitter buffer size is smoothly decreased by 10 ms, and 40 ms of signal are generated from 5 frames.

The PLC capability can be assisted by the independence of the coding of the data between frames and use of spectral components which are amenable to interpolation/extrapolation.

Since each frame is encoded independently, loss of a frame, which is typical of IP networks, has only a local effect, and does not affect decoding of surrounding frames.

It is noted that embodiments of the codec presented herein is particularly useful for speech and for music.

As described above, the codec presented herein is a low latency codec, since encoding optionally does not introduce any algorithmic latency, and decoding optionally introduces a latency of one data frame.

It is noted that the codec presented herein can be particularly useful for IP networks. Especially, the PLC feature is useful for IP networks, where packets may be lost. More specifically, the codec is useful for Voice over IP (VoIP) applications, where low latency and PLC work together, enhancing the usefulness.

It is expected that during the life of a patent maturing from this application many relevant forms of data frames, data transforms, and psychoacoustic models will be developed and the scope of the terms data frames, data transforms, and psychoacoustic models are intended to include all such new technologies a prior.

As used herein the term “about” refers to ±20%.

The terms “comprises”, “comprising”, “includes”, “including”, “having” and their conjugates mean: “including but not limited to”.

As used herein, the singular form “a”, “an” and “the” include plural references unless the context clearly dictates otherwise. For example, the term “a compound” or “at least one compound” may include a plurality of compounds, including mixtures thereof.

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

What is claimed is:

1. A method for encoding data, comprising processing the data one data window at a time, as follows:
computing spectral components of data of a first frame of data using data from the one data window;
selecting prominent spectral components of the data using a selection method appropriate for the data; and
quantizing the prominent spectral components, thereby producing a frame of encoded data.

2. The method of claim 1 in which the frame of encoded data is smaller than the first frame of data, thereby achieving data compression.

3. The method of claim 1 in which the frame of encoded data is packaged into one transmission packet.

4. The method of claim 1 in which the computing spectral components is performed separately for spectral components of a frequency above a specific frequency and separately for spectral components of a frequency below the specific frequency.

5. The method of claim 1 in which the computing the spectral components of the data is performed independently of data external to the first data frame.

6. The method of claim 1 in which the one data window is larger than the first data frame and computing the spectral components of data of a first frame of data comprises using data from the one data window.

7. The method of claim 1 in which the encoding is performed with zero algorithmic latency.

8. The method of claim 1 in which the selection method is based, at least partly, on a model of spectral distribution of the data.

9. The method of claim 1 in which the data comprises audio data.

10. The method of claim 9 in which the selection method is based, at least partly, on a psychoacoustic model.

11. The method of claim 1 in which the quantizing the prominent spectral components is performed independently for amplitude and phase of each frequency of the prominent spectral components.

12. The method of claim 11 in which the quantizing of the phase of a specific prominent spectral component is performed with a number of quantizing bits based, at least partly, on the frequency of the specific prominent spectral component and on at least one psychoacoustic criterion.

13. A method for decoding data including frames of encoded data, by performing, for each frame:
de-quantizing the frame of encoded data, thereby producing a frame of de-quantized encoded data;
smoothing continuity of the de-quantized encoded data based, at least in part, on comparing values of the de-quantized encoded data with values of de-quantized encoded data of a prior frame, thereby producing a frame of smoothed data; and
transforming the frame of smoothed data to a frame of time domain data.

14. The method of claim 13 in which the smoothing continuity of the de-quantized encoded data is performed by using a Gale-Shapley pairing method, and interpolating between each pair of values.

15. The method of claim 13 in which the decoding is performed with a latency of one frame.

16. The method of claim 13, used to implement a dynamic jitter buffer.

17. The method of claim 13 in which the frame of time domain data is of a different duration from a duration of a data window used to produce the frame of encoded data.

18. A method for decoding a data stream including frames of encoded data, by performing, for each frame:
de-quantizing a first frame of encoded data, thereby producing a first frame of de-quantized encoded data;
transforming the frame of de-quantized encoded data to a frame of time domain data;
producing a second frame of approximate encoded data based, at least in part, on the first frame of encoded data; and
transforming the second frame of approximate encoded data to a second frame of time domain data.

19. The method of claim 18 and further comprising:
de-quantizing a second frame of encoded data, thereby producing a third frame of de-quantized encoded data;
transforming the third frame of de-quantized encoded data to a third frame of time domain data; and
replacing the second frame of time domain data with the third frame of time domain data.

20. The method of claim 19 and further comprising:
playing back the second frame of time domain data; and
while playing back the second frame of time domain data switching to playing back the third frame of time domain data.

21. The method of claim 18 in which if a frame of encoded data is late arriving from the data stream, a replacement frame of encoded data is produced.

22. The method of claim 18 in which if more than one frame of encoded data are missing from the data stream, more than one replacement frame of encoded data are produced.

23. The method of claim 18 in which the replacement frame of encoded data is produced based, at least in part, on extrapolating from a prior frame of encoded data.

24. The method of claim 18 in which the replacement frame of encoded data is produced based, at least in part, on interpolating between a prior frame of encoded data and a subsequent frame of encoded data.

25. Apparatus for encoding a stream of data comprising:
a spectral analysis unit configured for computing spectral components of the data,
a selection unit configured for selecting prominent spectral components of the data; and
a quantizing unit configured for quantizing the prominent spectral components thereby producing a frame of encoded data.

26. Apparatus for decoding a data stream including frames of encoded data comprising:
a de-quantizing unit configured for de-quantizing each frame of encoded data, thereby producing a frame of de-quantized encoded data;
a track matching unit configured for:
smoothing continuity of the de-quantized encoded data, based at least in part on pairing values of the de-quantized encoded data with values of de-quantized encoded data of a prior frame, thereby producing a frame of smoothed data; and
transforming the frame of smoothed data to a frame of time domain data.

27. A codec scheme comprising:
encoding data, by processing the data one data frame at a time, as follows:
computing spectral components of the data;
selecting prominent spectral components of the data using a selection method appropriate for the data;
quantizing the prominent spectral components thereby producing a frame of encoded data; and
appending each frame of encoded data to a prior frame of encoded data, thereby producing encoded data frames; and
decoding the encoded data frames by processing the encoded data frames one frame at a time, as follows:
de-quantizing the encoded data frame, thereby producing a frame of de-quantized encoded data;
smoothing continuity of the de-quantized encoded data based, at least in part, on pairing values of the de-quantized encoded data with values of de-quantized encoded data of a prior frame, thereby producing a frame of smoothed data;
transforming the frame of smoothed data to a frame of time domain data; and
appending each frame of time domain data to a prior frame of time domain data, thereby producing frames of time domain data.

28. The codec scheme of claim 27 in which the data comprises audio data.

29. The codec scheme of claim 28, in which the codec is a wideband codec, and a width of the data frame is about 10 milliseconds.

30. The codec scheme of claim 28, in which the codec is a wideband codec, and the audio data is sampled at a frequency of about 16,000 Hz.

31. The codec scheme of claim 27 in which if a frame of encoded data is missing from the encoded data frames, a replacement frame of encoded data is produced.

32. The codec scheme of claim 27 in which if a frame of encoded data is found to contain errors, a corresponding replacement frame of time domain data is produced.

33. The codec scheme of claim 27 in which the encoding involves no algorithmic latency.

34. The codec scheme of claim 27 in which the decoding involves latency of only one frame of encoded data.

35. Circuitry configured to implement the codec scheme of claim 27.
